(19) United States
(12) Patent Application Publication
(10) Pub. No.: US 2015/0057581 A1
(43) Pub. Date: Feb. 26, 2015

(54) STIMULATION DEVICE

(71) Applicant: Warren Peak, Auburn, CA (US)

(72) Inventor: Warren Peak, Auburn, CA (US)

(21) Appl. No.: 14/257,995

(22) Filed: Apr. 21, 2014

Related U.S. Application Data
(60) Provisional application No. 61/869,934, filed on Aug. 26, 2013.

(51) Int. Cl. A61H 23/00; A61H 19/00

(52) U.S. Cl. CPC A61H 23/00; A61H 19/44
USPC 601/46

(57) ABSTRACT

Devices and associated methods for a vibrating body or condom insert are disclosed. In specific embodiments, the insert is manufactured to provide externally a one-piece device with embedded electrical components.

### CROSS REFERENCE TO RELATED APPLICATIONS

This application claims priority from provisional patent application 61/869,934 filed Aug. 26, 2013 and incorporated herein by reference.

### COPYRIGHT NOTICE

Pursuant to 37 C.F.R. 1.71(e), Applicants note that a portion of this disclosure contains material that is subject to and for which is claimed copyright protection (such as, but not limited to, drawings and/or design elements). The copyright owner has no objection to the facsimile reproduction by anyone of the patent document or patent disclosure, as it appears in the

Patent and Trademark Office patent file or records. All other rights are reserved, and all other reproduction, distribution, creation of derivative works based on the contents, public display, and public performance of the application or any part thereof are prohibited by applicable copyright law.

### FIELD OF THE INVENTION

Specific embodiments herein relate generally to a vibrating insert that comfortably fits along or on the shaft of a penis or other phallic shaped object. Specific embodiments have a design form to facilitate use with a condom.

### BACKGROUND OF THE INVENTION

The adult novelty industry is experiencing significant growth, inspiring innovation and investment in expanding product diversity. One category of these products, known also as marital aids, sex toys or pleasure products, operates by producing vibrations, thereby providing increased stimulation to genital areas. Vibrating devices for marital aid or sexual stimulation generally use “bullet” style of vibrating element. This is an electric motor with offset counterweight, enclosed in a cylindrical shell with rounded ends. This generally limits its applicability in the design of such products.

Thus, vibrating devices for increasing sexual stimulation for men or women or both are widely known in the art.

A common vibrator design involves a ring or band or similar structure that is generally worn around the penis, usually at the base, to provide enhanced sexual stimulation for the wearer and also for a sexual partner.

Another proposed common vibrator design involves a condom that incorporates vibrating elements. Generally, these vibrating elements are integrated into the condom, either permanently or through the use of pouches in the condom, though some various vibrating elements have been described that are used with a condom and not necessarily integrated with the vibrating device.

While a number of different vibrators have been proposed, many of these designs result in devices that are cumbersome, not particularly easy to wear, and otherwise do not provide an appealing experience.

### SUMMARY

Specific embodiments of a device as described herein involve a generally smooth flexible body that can be placed along the shaft of a penis or of a penis-shaped device and then held in place by a condom or a separable or attached elastic band. The body generally has inside it one or more electrical elements to provide vibrations, electrical stimulation, light, heat, or other sensations to enhance sexual pleasure. The device may be connected to a power supply through a flexible wire that connects the device to an external power source or the device may have a battery or other power storage element incorporated into the device, such as a rechargeable battery. Specific embodiments comprise one smooth elongated insert to be held in place by a condom, thus greatly improving the aesthetic look of the device and the ease of placement and wearing of the device. Other embodiments may include a ring or sleeve that fits over and encircles or partially encircles a penis.

In specific embodiments, the device is made of a plastic or rubber or similar material. In preferred embodiments, silicone is used, as it provides flexibility and durability. Because of the unique design of the device, according to specific embodiments, it is ideal for distribution with a condom and can be easily stored, packaged for sale, etc.

Thus, specific embodiments provide new and improved stimulation devices and methods for the same that have a simplicity in form and use and is simple to wear and clean.

### Other Features & Benefits

The invention and various specific aspects and embodiments will be better understood with reference to the following drawings and detailed descriptions. In different figures, similarly numbered items are intended to represent similar functions within the scope of the teachings provided herein. In some of the drawings and detailed descriptions below, the present invention is described in terms of the important independent embodiment of specific vibrating inserts specific design and construction, in some cases including specific materials. This should not be taken to limit the invention, which, using the teachings provided herein, can encompass a variety of different materials of construction and a variety of different design elements. It is therefore intended that the invention not be limited except as provided in the attached claims.

### BRIEF DESCRIPTION OF THE DRAWINGS

FIG. 1 is a diagram showing a general shape of a condom insert with embedded electric elements and an optional electrical connector according to specific embodiments.

FIG. 2A is a photograph of a top pan view of a prototype device made using a to transparent material in order to show wiring and placement of embedded electric elements and an optional electrical connector according to specific embodiments.

FIG. 2B is a photograph of a bottom pan view of a prototype device according to specific embodiments.

FIG. 3A is a photograph of a top pan view of a prototype device placed over a phallic shaped object to demonstrate initial placement of the device according to specific embodiments.

FIG. 3B is a photograph of a top pan view of a prototype device placed over a phallic shaped object with a condom partially rolled onto the device and object to demonstrate wearing the device with a condom.

FIG. 4 is a diagram showing different views of a flexible circuit board including vibrating elements and electrical connections according to specific embodiments.

FIG. 5 is a side view of an insert according to a first specific embodiment.

FIG. 6 is a side view of an insert according to the first specific embodiments showing flexion in a first direction.

FIG. 7 is a side view of an insert according to the first specific embodiments showing flexion in a second direction.

FIG. 8 is a side elevation view of an insert according to the first specific embodiments.

FIG. 9 is a rear view of a plurality of inserts according to the first specific embodiment.

FIG. 10 is a front view of an insert according to the first specific embodiments.

FIG. 11 is a front top surface elevation view of an insert according to a second specific embodiment.

FIG. 12 is a side top surface elevation a side view of an insert according to the second specific embodiments showing flexion in a first direction.

FIG. 13 is a back top surface elevation a side view of an insert according to the second specific embodiments showing flexion in a first direction.

FIG. 14 is a front underside surface elevation view of an insert according to a second specific embodiment.

FIG. 15 is a side underside surface elevation a side view of an insert according to the second specific embodiments showing flexion in a first direction.

FIG. 16 is a back underside surface elevation a side view of an insert according to the second specific embodiments showing flexion in a first direction.

### DESCRIPTION OF SPECIFIC EMBODIMENTS

A novel pleasure product according to specific embodiments comprises a thin layer or body of flexible material with a plurality of miniaturized vibrating or otherwise stimulating elements integrated within the body. To use, in specific embodiments the product is applied to a phallic member along its length and partially around its circumference. A condom or elastic bands are then applied to hold the device in place. The location of the vibrating elements provides stimulation generally at a plurality of locations along the length of the penis to be experienced by both partners. In specific embodiments, a controller device provides electric power to vary the amount of stimulation produced or to provide various patterns or rhythms of the stimulating components. Elastic straps may be integrated or attached to the device to allow use without a condom.

In further embodiments, a stimulating body using the teachings provided herein may be a ring or sleeve that encircles or partially encircles a penis or other phallic shaped object.

In specific embodiments of the device, the membrane or body material can be soft for comfort or hard for erectile enhancement, or a combination of rigidities to be harder on the inside and softer on the outside.

Various vibrating or stimulating components can be used, though in preferred embodiments the stimulating or vibrating components are small enough to allow their placement within the membrane to be evenly distributed or in patterns. In other embodiments, the membrane itself or parts thereof could be constructed to provide a vibrating or pulsing mechanism.

In specific embodiments, one or more electronic controls can be used to switch stimulations in particular patterns, such as sequentially for traveling pulse or other such sensations.

In further embodiments, different sizes and shapes of the device can be made for different customers or for different markets.

Thus, specific embodiments comprise one or more of the following features: (1) a vibrating device that can provide stimulation for two partners at the same time, for example to during intercourse, while minimally interfering with the natural shape and movement of the penis; (2) a device that can be applied to any phallic object; (3) a device that can make use of a condom more appealing or can be used to promote condom use or sales or both.

In further embodiments, more than one device can be worn at the same time, for example on two different surfaces of a penis. This allows for novel uses and also can be used to provide greater erectile support.

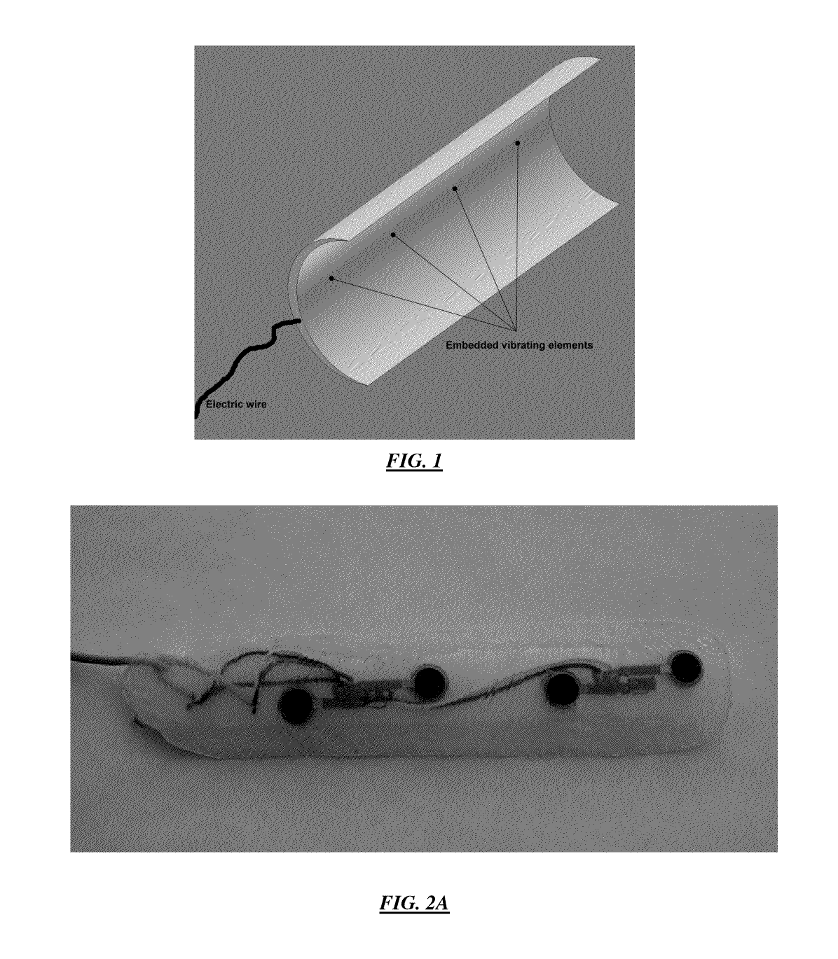

FIG. 1 is a diagram showing a general shape of a condom insert with embedded electric elements and an optional electrical connector according to specific embodiments. As illustrated, one general shape according to specific embodiments comprises a concave membrane designed to fit around a portion of a phallic object. For clarity, this discussion will refer to the two larger surfaces as the top and bottom surfaces and the connecting area as the sides or edges. While inserts shapes can vary, according to specific embodiments, the insert has a generally elongate shape. The inserts comprise a body with top and bottom surfaces that are generally rectangular or can have variable rounded corners making them more elliptical at one or more ends, for example to conform to the shape of the head of a penis. The edges can be thicker at one end, as roughly illustrated in the two shorter edges, or can be tapered, as illustrated on the longer edges. According to specific embodiments, a stimulating device body generally is thicker nearer the center of the surfaces to provide sufficient thickness to contain one or more electrical elements as shown and may be generally thinner or tapered at one or more edges to provide comfort while worn and to facilitate use with a condom.

In specific embodiments, the insert has a smoothed elongate shape so that it can rest along side the shaft of the penis or a phallic object. Specific relative dimensions and number of elements shown in the figures are examples and inserts of a wide range of sizes can be constructed according to various specific embodiments. In various designs, one or both surfaces are designed to be worn against the shaft of a penis or dildo, with the other surface generally coming in contact with and held in place by a condom. Optional electrical connections may be provided to allow for electrical power or control from a unit separate from the device or outside of the device body. Where power or control elements are contained in the device, these connections may be detachable to allow for charging a battery in the device from an external source or may provide inductive connection to allow for charging a battery without making a direct electrical connection.

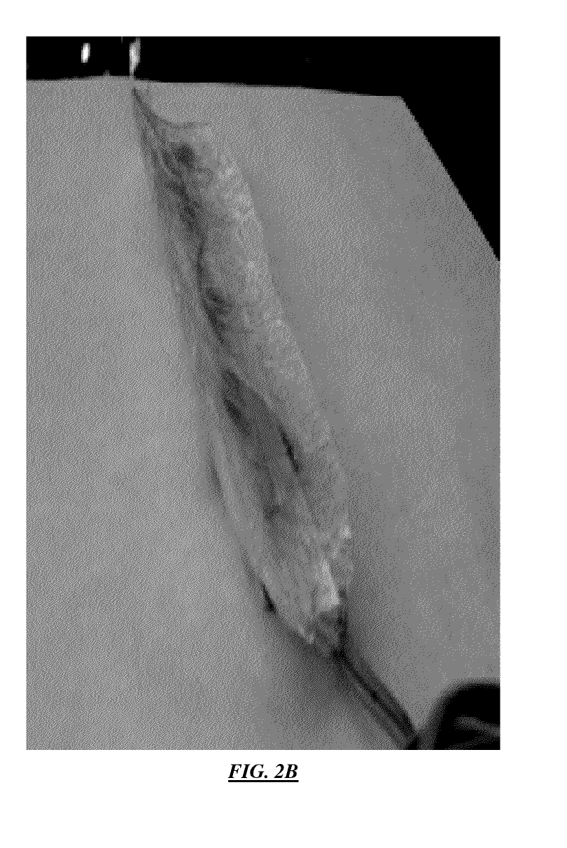

FIG. 2A is a photograph of a top pan view of a prototype device made using a to transparent material in order to show wiring and placement of embedded electric elements and an optional electrical connector according to specific embodiments. In this specific example embodiment, four electrical elements are shown, with wiring connecting the four elements. The four electrical elements can comprise standard pancake vibrating cell phone motors, which are commercially available at a variety of sizes, e.g. 10 mm×2-7 mm. Additional or other active electrical elements can be similarly incorporated, such as elements for providing heat or electrical stimulation or lights. One or more passive electric elements may also be incorporated into the devices, such as a battery or other energy storage device, a controller for providing various patterns or variations to the active elements, and transmitter devices for receiving or sending control information to a nearby wireless communication device. FIG. 2B is a photograph of a bottom pan view of the prototype device described above.

While various shapes and sizes are contemplated according to specific embodiments, several elements are incorporated in the embodiments shown in the following drawings.

In these specific embodiments, the device comprises a membrane body having a generally convex top surface, and a generally concave bottom surface. When worn, the concave bottom surface will be in contact with the penis shaft and the top surface will be in contact with a condom or other fastening mechanism. In these embodiments, the device has a tapered front end that when worn will generally be in contact with the head or glans of the penis. In these embodiments, the device has a flat or slightly rounded or tapered back end that when worn will generally be in the vicinity of the pubis or pubic bone or resting against the skin and tissue covering the pubic bone. In this position, the back end provides some support to keep the device from slipping down the penis during sexual intercourse.

In further embodiments, the device is constructed to have flexibility in several dimensions, while being substantially resistant to tension or compression that would tend to change the length of the device between the front end and the back end or the width of the device between the two sides. This also provides some additional support for the device while in use during sexual intercourse and also protects circuit elements from becoming disconnected if the device were pulled between front end and back end. In alternative embodiments, electronic components are connected by stretchable and/or flexible connectors or conductors and thus additional tensile strength in the shaft direction is not needed.

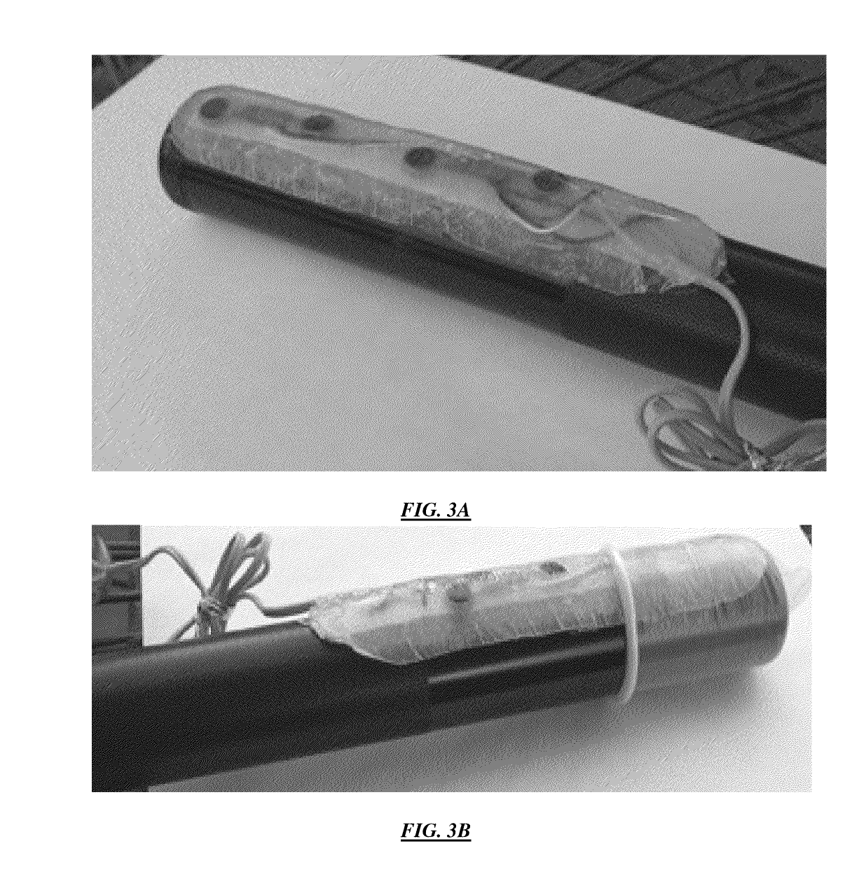

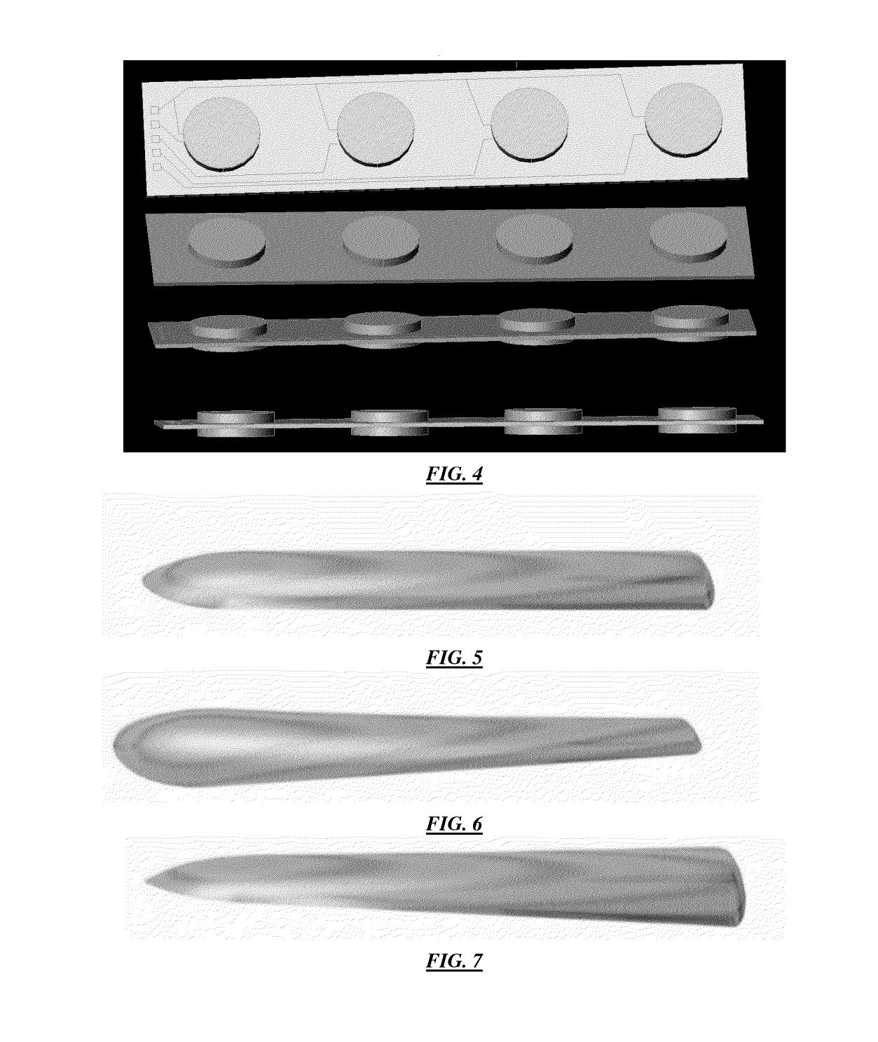

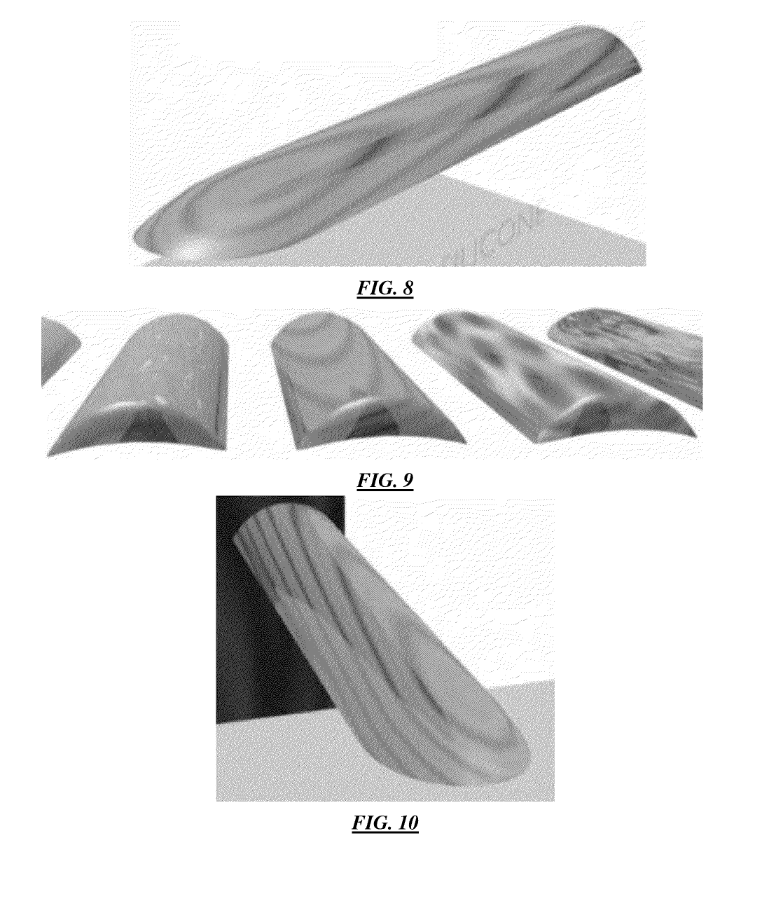

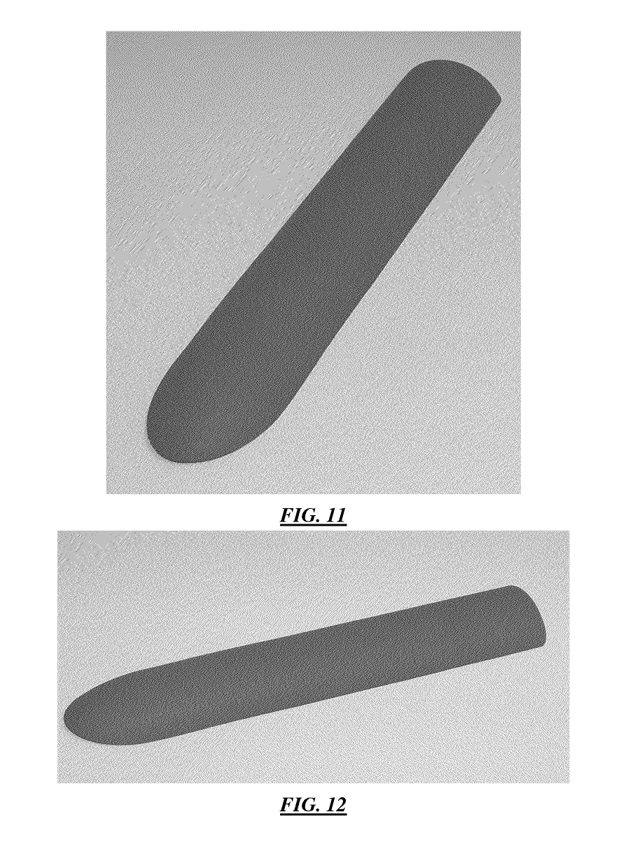

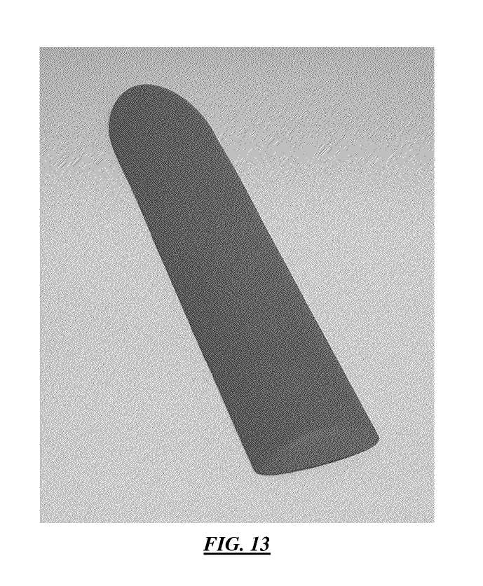

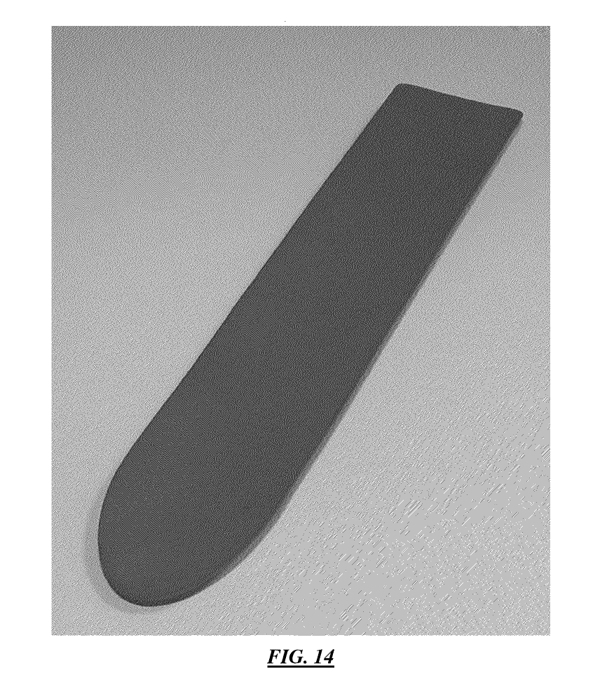

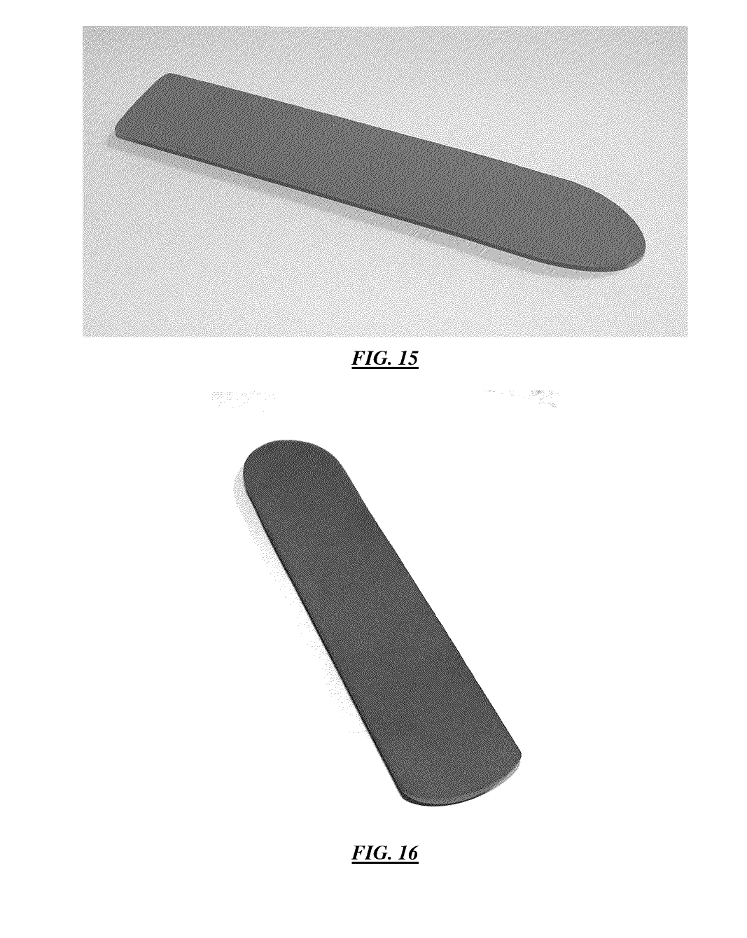

FIG. 3A is a photograph of a top pan view of a prototype device placed over a phallic to shaped object to demonstrate initial placement of the device according to specific embodiments.

As illustrated in the figure, the device can easily and comfortably be placed along a phallus with little disturbance to the overall shape of the device and can be put on as easily as a condom. FIG. 3B shows the application of a condom onto the device according to specific embodiments.

FIG. 4 is a diagram showing different views of a flexible circuit board including vibrating elements and electrical connections according to specific embodiments.

### Manufacture

In particular embodiments, the inserts can be understood to be constructed as a single molded piece of. Such a one-piece molded construction may reduce manufacturing and handling costs, allows for easy handling and cleaning by the end user, and is aesthetically pleasing. The insert will generally be constructed from a single piece of molded plastic or silicone with stimulating components, other electronic components, and optionally tensile components embedded therein, but other suitable materials may be used. In any case, according to specific embodiments of the present invention, one advantage of the design is that insert can be, though is not necessarily, constructed as a single piece or molded as a single piece with embedded elements as described herein. Embedded elements can include electrical components as described herein. Embedded elements optionally can also include one or more stiffening components to provide tensile or compression strength in one or more directions, though particularly in a direction along a penis length.

According to specific embodiments of the invention, the insert may be constructed of a translucent or transparent material, such as a translucent plastic or silicone. The translucent material allows easy display of visual elements, such as lights or LEDs, and also may provide for interesting aesthetics. The translucent material may comprise colorless or colored translucent plastic or silicone.

### CONCLUSION

It is understood that the examples and embodiments described herein are for illustrative purposes and that various modifications or changes in light thereof will be suggested by the teachings herein to persons skilled in the art and are to be included within the spirit and purview of this application and scope of the claims.

All publications, patents, and patent applications cited herein or filed with this application, including any references filed as part of an Information Disclosure Statement, are to incorporated by reference in their entirety.

1. A vibrating or stimulating device comprising:
a body having a first surface, a second surface, and one or more sides or edges connecting the first surface and the second surface;
the first and second surfaces having a length greater than 70% of a length of an average penis;
the first and second surfaces having a width less than 50% of a girth or circumference of an average penis;
a plurality of electronic vibrating components embedded in the body between said first surface and said second surface;
one or more electrical connectors embedded in the body connecting one or more of the electronic component to each other or to a power supply or to control signals or to any combination of each other, a power supply and control signals;
the body configured to be placed alongside a portion of a penis or other phallic shaped object without encircling the penis or other phallic object;
wherein the body allows some flexion in a direction parallel to the penis girth or circumference;
wherein the body allows some flexion in a direction parallel to the penis shaft;
wherein the body resists compression or tension in a direction parallel to the penis shaft; and
the body configured to allow placement of a condom over said body.

2. The device according to claim 1 further comprising:
the body having a greater thickness between the first surface and the second surface at a center of the first surface or the second surface or both;
the body having a lesser thickness near one or more of the one or more of sides or edges;
the one or more sides or edges comprising a continuous edge with varying thickness and varying degrees of tapering.

3. The device according to claim 1 further comprising:
the one or more sides or edges comprising a thinner tapered curved edge configured to rest against the penis head when worn; and
the one or more sides or edges comprising a thicker, less tapered, substantially straight edge configured to rest at the base of the penis and against a pubic region.

4. The device according to claim 1 wherein the body is manufactured from one or more of silicone, plastic, metal, polymers.

5. The device according to claim 1 further comprising one or more of:
one or more energy storage components embedded in the body;
one or more electronic controllers embedded in the body;
one or more wireless or mechanical control switches embedded in the body;
one or more controllers providing multiple vibration modes.

6-7. (canceled)

8. A vibrating or stimulating device comprising:
a body having a first surface, a second surface, and an edge connecting the first surface and the second surface;
a plurality of electronic components embedded in said body between said first surface and said second surface;
one or more electrical connectors embedded in said body, connecting one or more of said electronic components to each other and providing one or more connections to power or to control signals or both;
said body configured to be placed alongside a portion of a penis or other phallic shaped object without encircling the penis or other phallic object; and
said body configured to allow placement of a condom over said body.

9. The device according to claim 8 wherein the body conforms to the curvature of a penis without completely encircling any part of the penis and is elongate in a direction parallel to the shaft of a penis.

10. (canceled)

11. The device according to claim 8 wherein the body is elongate in a direction parallel to the shaft of a penis and of a length at least 70% of an averaged length erect penis.

12. The device according to claim 8 wherein the body is elongate in a direction parallel to the shaft of a penis and is in contact with no more than 50% of girth or circumference of the penis.

13. The device according to claim 8 wherein the body is manufactured as a single unit from one or more materials, with the electronic components and the electronic connectors embedded therein, the materials comprising one or more of silicone, plastic, metal, polymers.

14. (canceled)

15. The device according to claim 8 wherein the body is concave to conform to the shape of a penis.

16. The device according to claim 8 wherein the body has a greater thickness between the first surface and the second surface at a center of the first surface and a lesser thickness near one or more edges.

17. (canceled)

18. The device according to claim 8 wherein the body is more flexible in a direction parallel to girth or circumference of a penis when worn and more rigid in a direction parallel to a shaft length of a penis.

19. The device according to claim 8 wherein the body comprises smooth edges and surfaces so that a condom can be easily put over the body and a penis when worn.

20. The device according to claim 8 further comprising one or more of:
an energy storage component embedded in the body;
one or more electronic controllers embedded in the body;
one or more wireless or mechanical control switches embedded in the body.
a controller providing multiple vibration modes.

21-23. (canceled)

24. The device according to claim 8 further comprising:
a thicker edge portion configured to be worn near a pubis bone and configured to rest against a the pubis bone to provide stability of the device during thrusting, and a thinner edge portion configured to be worn near the head of a penis.

25. (canceled)

26. The device according to claim 8 further comprising:
at least two separate vibrating elements,
at least one configured to be near the head of a penis when the device is worn and to provide vibrational stimulation to the head of the penis and inside a partner during intercourse;
at least one configured to be near the base of the penis when the device is worn and to provide vibrational stimulation at the base of the penis and to the external genitals of a partner during intercourse.

27. (canceled)

28. A vibrating or stimulating ring or sleeve comprising:
a body having a first surface, a second surface, and one or more edges connecting the first surface and the second surface;
a plurality of electronic components embedded in said body between said first surface and said second surface;
one or more electrical connectors embedded in said body, connecting one or more of said electronic components to each other and providing one or more connections to power or to control signals or both;
said body configured to be placed alongside or encircling a portion of a penis or other phallic shaped object; and
said body configured to provide a smooth form to allow placement of a condom over or under said body.

29. The device according to claim 28 further comprising:
at least one thicker edge configured to be worn at the base of a penis and in contact with a pubic area;

30. The device according to claim 28 further comprising:
at least one tapered edge configured to be worn on the penis towards the head, allowing for easier placement of a condom over the body.

31. (canceled)
